(19) United States
(12) Patent Application Publication
(10) Pub. No.: US 2022/0387885 A1
(43) Pub. Date: Dec. 8, 2022

(54) DYNAMIC MODIFICATION OF MULTIPLE HAPTIC EFFECTS

(71) Applicant: Immersion Corporation, San Francisco, CA (US)

(72) Inventors: Sagi Sinai-Glazer, Westmount (CA); Jamal Saboune, Montreal (CA)

(21) Appl. No.: 17/778,313

(22) PCT Filed: Nov. 11, 2020
(86) PCT No.: PCT/US2020/060057

§ 371 Date: May 19, 2022

Related U.S. Application Data
(60) Provisional application No. 62/937,539, filed on Nov. 19, 2019.

(51) Int. Cl. A63F 13/285; G06F 3/01

(52) U.S. Cl. CPC A63F 13/285; G06F 3/016

(57) ABSTRACT

Providing haptic feedback includes identifying a three-dimensional (3D) area around a user. The 3D area is divided into a plurality of 3D sectors. At least one haptic effect is determined based on content displayed relative to the 3D area. At least one haptic effect is modulated by determining, for each of the 3D sectors, at least one weighted haptic effect. A modified haptic effect is generated for each of the 3D sectors based on a sum of the at least one weighted haptic effect. The haptic feedback is provided in response to a haptic control signal including instructions to playback a basic haptic pattern, the basic haptic pattern being transcoded from the modulated haptic effect. Numerous other aspects are provided.

### CROSS REFERENCE TO RELATED APPLICATION

This application claims priority to U.S. Application No. 62/937,539 filed on Nov. 19, 2019, and entitled “Dynamic Modification of Multiple Haptic Effects,” the entirety of which is incorporated herein by reference.

### FIELD OF INVENTION

Embodiments of the present invention are generally directed to dynamic modification of multiple haptic effects for providing haptic feedback.

### BACKGROUND

Haptics relate to tactile and force feedback technology that takes advantage of an individual's sense of touch by applying haptic feedback effects (i.e., “haptic effects”), such as forces, vibrations, and motions, to the individual. Devices, such as mobile devices, touchscreen devices, and computers, can be configured to generate haptic effects. For example, if a user interacts with the device using, for example, a button, touchscreen, lever, joystick, wheel, or some other control element, the operating system of the device can send a command through control circuitry to produce the appropriate haptic effect.

Haptic effects were traditionally designed for two-dimensional (“2D”) spaces and designed to be rendered at 100% strength. Thus, a traditional haptic effect design was intended to compliment a viewer closely-located to and looking straight at a haptic effect source, e.g., content or object(s) shown on a display.

To address complex movement of the viewer in relation to the content, attempts have been made to position the haptic effect(s) in space (e.g., up, down, left and/or right). However, these attempts have been confusing and inaccurate.

### SUMMARY

Embodiments of the present invention are generally directed to dynamic modification of multiple haptic effects for providing haptic feedback.

According to certain embodiments of the present invention, a method of providing haptic feedback includes identifying a three-dimensional (3D) area around a user; dividing the 3D area into a plurality of 3D sectors; determining at least one haptic effect based on content displayed relative to the 3D area, the content comprising at least one object displayed in at least one 3D sector of the plurality of 3D sectors; modulating the at least one haptic effect by determining, for each of the plurality of 3D sectors, at least one weighted haptic effect; generating a modified haptic effect for each of the plurality of 3D sectors based on a sum of the at least one weighted haptic effect; and providing the haptic feedback in response to a haptic control signal including instructions to playback a basic haptic pattern, the basic haptic pattern being transcoded from the modulated haptic effect.

In some embodiments, the 3D area is shaped in the form of a sphere, each of the plurality of 3D sectors is shaped in the form of a rectangular pyramid, and a total number of the plurality of 3D sectors is in a range between 16 to 360.

In certain embodiments, the at least one weighted haptic effect is determined based on an angle at which the user views the at least one object.

In some embodiments, determining the at least one haptic effect includes: determining a first haptic effect based on a first object displayed in a first 3D sector of the plurality of 3D sectors; and determining a second haptic effect based on a second object displayed in a second 3D sector of the plurality of 3D sectors; and modulating the at least one haptic effect includes: determining a first weighted haptic effect for each of the plurality of 3D sectors; and determining a second weighted haptic effect for each of the plurality of 3D sectors; the method further includes: transcoding the sum of the first weighted haptic effect and the second weighted haptic effect for the first 3D sector into a first basic haptic pattern; and transcoding the sum of the first weighted haptic effect and the second weighted haptic effect for the second 3D sector into a second basic haptic pattern, the first basic haptic pattern and the second basic haptic pattern being stored in a single haptic file; wherein: providing the haptic feedback further includes: loading the single haptic file in a playback queue, rendering, at a first timestamp, a first modified haptic effect by playback of the first basic haptic pattern, and rendering, at a second timestamp, a second modified haptic effect by playback of the second basic haptic pattern, the second timestamp occurring after the first timestamp, and the rendering of the second modulated haptic effect at least partially overlapping with the rendering of the first modulated haptic effect.

The rendering of the second modified haptic effect, in certain embodiments, occurs in response to a change in a point-of-view of the user.

The at least one weighted haptic effect, in some embodiments, is based on an importance of the at least one object to the point-of-view of the user.

According to certain embodiments of the present invention, a method of providing haptic feedback includes: identifying an area around a user; pre-transcoding a first original haptic effect into a set number of strength levels x1+n, n being an integer equal to or greater than 0, pre-transcoding a second original haptic effect into a set number of strength levels y1+n, n being an integer equal to or greater than 0, the first original haptic effect the second original haptic effect being rendered based on at least one object; providing the haptic feedback in response to a haptic drive signal, the haptic drive signal comprising instructions for simultaneous rendering of the first original haptic effect and the second original haptic effect; and modulating the simultaneous rendering of the first original haptic effect and the second original haptic effect by rendering at least one of (i) a first modulated haptic effect at a first strength level x1 from among the set number of strength levels x1+n, or (ii) a second modulated haptic effect at a second strength level y1 from among the set number of strength levels y1+n.

In some embodiments, the providing of the haptic feedback and the modulating of the simultaneous rendering of the first original haptic effect and the second original haptic effect occur in real-time.

In certain embodiments, the first strength level x1 is different than an initial strength level x0 of the first original haptic effect, or the second strength level y1 is different than an initial strength level y0 of the second original haptic effect.

The modulating of the simultaneous rendering of the first original haptic effect and the second original haptic effect, in some embodiments, includes rendering the first modulated haptic effect at the first strength level x1 and the second original haptic effect at the initial strength level y0.

The modulating of the simultaneous rendering of the first original haptic effect and the second original haptic effect, in certain embodiments, includes rendering the first modulated haptic effect at the first strength level x1 and the second modulated haptic effect at the second strength level y 1.

In some embodiments, the method further includes: repeating the modulating of the simultaneous rendering of the first original haptic effect and the second original haptic effect in response to movement of the user.

In certain embodiments, if the first original haptic effect is rendered by the first object and the second original haptic effect is rendered by the second object, the first strength level x1 is based on proximity of the first object to the user, and the second strength level y1 is based on proximity of the second object to the user, and if both the first original haptic effect and the second original haptic effect are rendered by the single object, the first strength level x1 and the second strength level y1 are based on proximity of the single object to the user.

In some embodiments, if the first original haptic effect is rendered by the first object and the second original haptic effect is rendered by the second object, the first strength level x1 is based on importance of the first object to the user, and the second strength level y1 is based on importance of the second object to the user, and if both the first original haptic effect and the second original haptic effect are rendered by the single object, the first strength level x1 and the second strength level y1 are based on importance of the single object to the user.

According to certain embodiments of the present invention non-transitory computer readable medium having instructions thereon that, when executed by a processor, cause the processor to perform operations includes: identifying, at a tracking system, a three-dimensional (3D) area around a user; dividing, at a haptic effect generator, the 3D area into a plurality of 3D sectors; modulating, at the haptic effect generator, a first haptic effect by determining, for each of the plurality of 3D sectors, a first weighted haptic effect; modulating, at the haptic effect generator, a second haptic effect by determining, for each of the plurality of 3D sectors, a second weighted haptic effect, either (i) the first haptic effect being rendered by a first object and the second haptic effect being rendered by a second object, or (ii) both the first haptic effect and the second haptic effect being rendered by a single object; generating, at the haptic effect generator, a modulated haptic effect for each of the plurality of 3D sectors based on a sum of the first weighted haptic effect and the second weighted haptic effect; and generating, at a haptic playback track generator, a haptic control signal including instructions to playback a basic haptic pattern to provide haptic feedback, the basic haptic pattern being transcoded from the modulated haptic effect.

The 3D area, in some embodiments, is shaped in the form of a sphere, each of the plurality of 3D sectors is shaped in the form of a rectangular pyramid, and a total number of the plurality of 3D sectors is in a range between 16 to 360.

In certain embodiments, if the first haptic effect is rendered by the first object and the second haptic effect is rendered by the second object, the first weighted haptic effect is determined based on an angle at which the user views the first object and the second weighted haptic effect is determined based on the angle at which the user views the second object, or if the first haptic effect and the second haptic effect are rendered by the single object, both the first weighted haptic effect and the second weighted haptic effect are determined based on the angle at which the user views the single object.

In some embodiments, the first object is in a first 3D sector, and the second object is in a second 3D sector, the first 3D sector and the second 3D sector being among the plurality of 3D sectors, the sum of the first weighted haptic effect and the second weighted haptic effect, for the first 3D sector, is transcoded into a first basic haptic pattern, and the sum of the first weighted haptic effect and the second weighted haptic effect, for the second 3D sector, is transcoded into a second basic haptic pattern, the first basic haptic pattern and the second basic haptic pattern both being stored in a single haptic file, and the haptic feedback is provided by loading the single haptic file including the first basic haptic pattern and the second basic haptic pattern in a playback queue, rendering, at a first timestamp, a first modulated haptic effect by playback of the first basic haptic pattern, and rendering, at a second timestamp, a second modulated haptic effect by playback of the second basic haptic pattern, the second timestamp occurring after the first timestamp, and the rendering of the second modulated haptic effect at least partially overlapping with the rendering of the first modulated haptic effect.

The rendering of the second modulated haptic effect, in some embodiments, occurs in response to a change in a point-of-view of the user.

In certain embodiments, if the first haptic effect is rendered by the first object and the second haptic effect is rendered by the second object, the first weighted haptic effect is based on importance of the first object to the point-of-view of the user, and the second weighted haptic effect is based on importance of the second object to the point-of-view of the user, or if the first haptic effect and the second haptic effect are rendered by the single object, both of the first weighted haptic effect and the second weighted haptic effect is based on importance of the single object to the point-of-view of the user.

Another embodiment is directed to a method of providing haptic feedback includes identifying an area around a user. A first original haptic effect is pre-transcoded into a set number of strength levels x₁₊ₙ, n being an integer equal to or greater than 0. A second original haptic effect is pre-transcoded into a set number of strength levels y₁₊ₙ, n being an integer equal to or greater than 0. Either (i) the first original haptic effect is rendered by a first displayed object and the second original haptic effect is rendered by a second displayed object, or (ii) both the first original haptic effect and the second original haptic effect are rendered by a single displayed object. The haptic feedback is provided in response to a haptic drive signal. The haptic drive signal includes instructions for simultaneous rendering of the first original haptic effect and the second original haptic effect. The simultaneous rendering of the first original haptic effect and the second original haptic effect is modulated by rendering a first modulated haptic effect at a strength level x₁ from among the set number of strength levels x₁₊ₙ and a second modulated haptic effect at a strength level y₁ from among the set number of strength levels y₁₊ₙ.

Another embodiment is directed to a method of providing haptic feedback including identifying a three-dimensional (3D) area around a user. The 3D area is divided into a plurality of 3D sectors. At least one haptic effect is determined based on content displayed relative to the 3D area. The content includes at least one object displayed in at least one 3D sector of the 3D sectors. At least one haptic effect is modulated by determining, for each of the plurality of 3D sectors, at least one weighted haptic effect. A modified haptic effect is generated for each of the plurality of 3D sectors based on a sum of the at least one weighted haptic effect. The haptic feedback is provided in response to a haptic control signal including instructions to playback a basic haptic pattern. The basic haptic pattern is transcoded from the modified haptic effect.

Yet another embodiment is directed to a non-transitory computer readable medium having instructions thereon that, when executed by a processor, cause the processor to perform operations of identifying, at a tracking system, a three-dimensional (3D) area around a user. The 3D area is divided, at a haptic effect generator, into a plurality of 3D sectors. At the haptic effect generator, a first haptic is modulated by determining, for each of the plurality of 3D sectors, a first weighted haptic effect. At the haptic effect generator, a second haptic is modulated by determining, for each of the plurality of 3D sectors, a second weighted haptic effect. Either (i) the first haptic effect is rendered by a first displayed object and the second haptic effect is rendered by a second displayed object, or (ii) both the first haptic effect and the second haptic effect are rendered by a single displayed object. At the haptic effect generator, a modified haptic effect is generated for each of the plurality of 3D sectors based on a sum of the first weighted haptic effect and the second weighted haptic effect. At a haptic playback track generator, a haptic control signal is generated including instructions to playback a basic haptic pattern to provide haptic feedback, the basic haptic pattern being transcoded from the modified haptic effect.

### BRIEF DESCRIPTION OF THE DRAWINGS

Embodiments will be more clearly understood from the following detailed description taken in conjunction with the accompanying drawings. FIGS. 1-10 represent non-limiting, embodiments as described herein.

FIG. 1 is a flow diagram of providing haptic feedback by dynamically modifying two or more haptic effects in a XR environment according to an embodiment.

FIG. 2A is a diagram of an area around a user according to an embodiment.

FIG. 2B is a playback timing chart of the haptic effects shown in FIG. 2A.

FIG. 3 is a flow diagram of providing haptic feedback by dynamically modifying two or more haptic effects in a 360-degree video according to an embodiment.

FIG. 4 is a diagram of a 360-degree video sphere according to an embodiment.

FIG. 5 is a diagram of a sector of the 360-degree video sphere shown in FIG. 4.

FIG. 6A is a cross-sectional diagram of an area around a user of a 360-degree video sphere according to an embodiment.

FIG. 6B is a playback timing chart of the haptic effects shown in FIG. 6A.

FIG. 7 is a cross-sectional diagram of an area around a user of a 360-degree video sphere according to another embodiment.

FIG. 8 is a HAPT file format according to an embodiment.

FIG. 9 is block diagram of an editing system according to an embodiment.

FIG. 10 is a block diagram of a system in an electronic device according to an embodiment.

FIG. 11 is a cross-sectional diagram of an area around a user according to another embodiment.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations as come within the scope of the appended claims and their equivalents.

Embodiments of the present invention are generally directed to dynamically modifying multiple haptic effects for providing haptic feedback. More particularly, embodiments relate to dynamic modification and playback of multiple haptic effects in an extended reality (“XR”) environment. An XR environment refers to all real and virtual environments generated by computer technology, e.g., an augmented reality (“AR”) environment, a virtual reality (“VR”) environment, or a mixed reality (“MR”) environment. The haptic effects may be modified by modulating or adjusting the strength of each of the haptic effects and mixing the modulated haptic effects. The modified haptic effects may be based on the haptic editor's intent, the proximity of the user or viewer to the content, and/or the importance (for instance, based on the avatar/user's vision sight (including central and/or peripheral vision), hearing, taste or smell) of the content to the user or viewer. The modified haptic effects may create a more immersive experience for the user.

In one illustrative embodiment, a user may be using a wearable peripheral device, such as a head-mounted display (“HMD”), e.g., a VR head-mounted display or an AR head-mounted display. As different content, objects, events, environments, etc. are shown on the HMD, the system may provide haptic effects based on the users location and orientation relative to the content, objects, events, environments, etc. shown on the HMD using haptic output device(s).

For example, the user may be wearing the VR HMD that has an integrated system for providing haptic effects using haptic output device(s). The VR HMD may display a virtual environment with a car driving at a racetrack, and the user may move and change their orientation within the video by physically moving and changing orientation in the real world or by using a remote, game controller, or other suitable device. The user may first be watching the car driving around the racetrack. While watching the car, the haptic output device(s) may output a haptic effect, such as a vibration, to reflect the rumbling of the car's engine. As the car approaches the user's position in the video, the haptic effect being output may gradually increase.

The user may then turn so that the car is no longer in view, and instead the user is watching the crowd in the stands. Once the car is outside the line-of-sight of the user, the haptic effect based on the car stops being output. And once the crowd is within the line-of-sight of the user, another haptic effect based on the crowd is output. The user may walk towards the crowd in the stands. As the user approaches the crowd, the haptic effect being output based on the crowd gradually increases. By adjusting the haptic effects being output based on the orientation and location of the user relative to the content, the user may experience more realistic haptic effects and thus have a more immersive experience.

In another illustrative embodiment, the user may be wearing an AR HMD that has an integrated system for providing haptic effects using haptic output device(s). The AR HMD may display a virtual train passing in front of the user and a virtual building exploding in the peripheral vision of the user. The system may determine a first haptic effect based on the virtual train and a second haptic effect based on the virtual explosion. The first haptic effect and the second haptic effect may be simultaneously output using the haptic output device(s) or may be combined to create a single modified haptic effect that is output by the haptic output device(s).

The strength of the first haptic effect and the second haptic effect may be determined based on the distance and orientation of the user relative to the virtual train and the virtual explosion, respectively. For example, when the user is facing the virtual train with the virtual explosion in their peripheral vision, the first haptic effect based on the virtual train will be stronger than the second haptic effect based on the virtual explosion. As the user turns so that the virtual explosion is in the user's direct line-of-sight and the virtual train is in the user's peripheral vision, the first haptic effect based on the virtual train will be weaker than the second haptic effect based on the virtual explosion. The user may move within the augmented reality environment so that the user approaches the virtual explosion and the virtual train moves outside the line-of-sight of the user. As the user moves toward the virtual explosion, the second haptic effect based on the virtual explosion will gradually increase. And as the user turns so that the virtual train is outside the line-of-sight of the user, the first haptic effect will gradually decrease until it is no longer output when the virtual train can no longer be seen by the user.

In a VR environment, an experience takes place within a simulated and immersive environment that can be similar to or completely different from the real world. A person using VR equipment is able to look around the simulated environment, move around in the simulated environment, and interact with virtual features or items in the simulated environment. VR can incorporate auditory feedback, video feedback, haptic feedback, and other types of sensory feedback.

In an example application of embodiments in a VR environment, if a person is playing a video game from the perspective of an avatar and the avatar is running toward a moving train and away from an explosion, haptic effects could simultaneously be rendered for both the moving train and the explosion. In accordance with example embodiments, the strength of the haptic effect representing the vibrations from the moving train is increased in accordance with the haptic editor's intent based on the proximity of the avatar to the moving train, while the strength of the haptic effect representing the vibrations from the explosion is simultaneously decreased in accordance with the haptic editor's intent based on the proximity of the avatar to the explosion.

As another example embodiment, if the same avatar is near an approaching car, the strength of the haptic effect representing the car is increased in accordance with the haptic editor's intent as the avatar looks towards the car, and simultaneously, the strength of the haptic effect representing the vibrations from the moving train is decreased in accordance with the haptic editor's intent as the avatar looks away from the moving train. Here, the haptic effects are modulated in accordance with the vision of the avatar.

In an AR environment, an interactive experience of a real-world environment takes place where objects that reside in the real-world are enhanced by computer-generated, perceptual information across one or more sensory modalities including visual, auditory, haptic, somatosensory, and olfactory. Sensory information can be constructive (e.g., additive to the objects in the real-world environment) or destructive (e.g., masking of the object in the real-word environment) and is seamlessly interwoven with the physical world such that it is perceived as an immersive aspect of the real environment. In this way, AR alters one's ongoing perception of a real-world environment, whereas VR replaces the user's real-world environment with a simulated one.

In an example application of an AR environment, a museum visitor views, using a mobile device, a virtual simulation of two dinosaurs interacting with each other. A first dinosaur is running toward a second dinosaur that is roaring and standing near the viewer. To the viewer, the dinosaurs appear to be standing on the floor of the museum. In accordance with example embodiments, the strength of the haptic effect representing the vibrations from the first dinosaur running is increased in accordance with the haptic editor's intent based on both the vision of the viewer and the proximity of the viewer to the running dinosaur, while the strength of the haptic effect representing the vibrations from the roaring of the second dinosaur is adjusted in accordance with the haptic editor's intent based on the vision and hearing of the viewer (for instance, increased and decreased as the roaring increases and decreases).

In an MR environment, boundaries between real and virtual interactions are removed. The removal of the boundaries between real and virtual interactions occurs due to the partial or entire obstruction of digital objects in a real-world environment by physical objects and/or the partial or entire obstruction of physical objects in a virtual environment by virtual objects. AR provides an overlay of virtual content in a real-world environment in real-time, but the boundaries between the virtual content and real-world environment remain intact. However, MR provides an overlay of virtual content in a real-world environment where the virtual content is anchored to and interacts with physical objects in the real-world environment in real time and the virtual content can be interacted with by physical objects in the real-world environment.

In an example application of a MR environment, a user physically walks into a child's physical bedroom that is full of virtual toys. Haptic effects are being simultaneously rendered for a virtual jumping toy on the child's bed and a virtual remote-controlled car driving under the child's bed. In accordance with example embodiments, the strength of the haptic effect representing the vibrations from the jumping toy is increased in accordance with the haptic editor's intent based on the proximity of the viewer to the jumping toy and the editor's intent, while the strength of the haptic effect representing the vibrations from the remote-controlled car is adjusted in accordance with the haptic editor's intent based on both the vision of the viewer and the proximity of the viewer to the remote-controlled car. For instance, the strength of the haptic effect may be increased as the viewer watches the remote-controlled car driving from under the bed and approaching the viewer and may be decreased as the viewer watches the remote-controlled car passing by the viewer and driving back under the bed.

A 360-degree video (also known as immersive videos or spherical videos) is a video recording where a view in every direction is recorded at the same time using an omnidirectional camera or a collection of cameras. During playback, the viewer/user can control the viewing direction like a panorama. Playback can be viewed through an editing environment on a computer, a mobile device, or a head-mounted display (“HMD”). A 360 video can include entirely virtual objects or entirely real objects.

In an example application of a 360-degree video (“360 video”), a viewer is watching a 360 video including an moving car (a dynamic object), an explosion of a building (a stationary object) and a cheering crowd (a stationary object) where haptic effects could be simultaneously rendered for the moving car, the explosion, and/or the cheering crowd. In accordance with example embodiments, the haptic effect representing the vibrations from the moving car is felt in accordance with the haptic editor's intent based on the vision of the viewer (as the viewer looks at the moving car). When the explosion occurs, the strength of the haptic effect representing the vibrations from the explosion is increased in accordance with the haptic editor's intent as the vision of the viewer shifts from the moving car to the explosion, while the strength of the haptic effect representing the moving car decreases in accordance with the haptic editor's intent and the shift of the viewer's vision. As the viewer turns around to look at the cheering crowd with the explosion being in a peripheral vision of the viewer and the moving car being outside the vision of the viewer, the haptic effect for the moving car ceases in accordance with the haptic editor's intent, the haptic effect for the explosion decreases in accordance with the haptic editor's intent, and the haptic effect representing the noise from the cheering increases in accordance with the haptic editor's intent.

In order to provide the immersive experience of XR haptic playback, it is desirable to modify multiple haptic effects in relation to the viewer's direction/orientation and location in the XR space. This is achieved by (i) modulation of multiple haptic effects (e.g., modulating the strength of the haptic effects) and (ii) simultaneously rendering the modulated haptic effects and/or mixing the multiple modulated haptic effects to create a new haptic effect that is based on the modulated haptic effects playing in parallel to each other.

Because basic haptic playback is a transcoded output pattern of ON/OFF patterns to an application programming interface (API), modulating the haptic effects to be rendered during playback requires a new transcoded pattern of a haptic editor's intent (i.e., with a different value of at least one haptic parameter such as or strength, magnitude/amplitude, frequency, duration, etc.). Haptic playback technology determines how these modifications to the haptic effects are achieved. For instance, if the haptic playback technology supports magnitude/amplitude control, dynamic (or real-time) transcoding can be done in the software development kit (SDK) playback code. Alternatively, the haptic effects can be pre-transcoded (for instance, by transcoding the original haptic effects to generate several strength level tracks).

A SDK, as used herein, refers to a set of software development tools that allow the creation of applications for a certain software package, software framework, hardware platform, computer system, video game console, operating system, or similar development platform.

An API, as used herein, is a set of subroutine definitions, communication protocols, and tools for building software.

In order to mix haptic effects, basic haptic playback uses the API. So mixing haptic effects is restricted by the limitation(s) of the API. For instance, an API may only be able to handle a single request at one time. If a request A is being executed and a new request B is received, the API will stop playing the request A, and start playing the request B.

According to embodiments, interleaving-mixing can be used to mix two or more haptic effects that are playing in parallel (i.e., at the same time). To achieve mixing by interleaving the haptic effects, the vibrate pattern must be kept short so as to prevent the loss of a large amount of the haptic effects. The size of the vibrate pattern is determined by experimenting with different values.

Dynamic modification of multiple haptic effects in a XR environment using a basic haptic device will now be described in detail. In the XR environment, a viewer can change direction and/or location. Two or more haptic effects can be played in parallel. If the haptic effects have the same priority, playback of the haptic effects can occur in parallel.

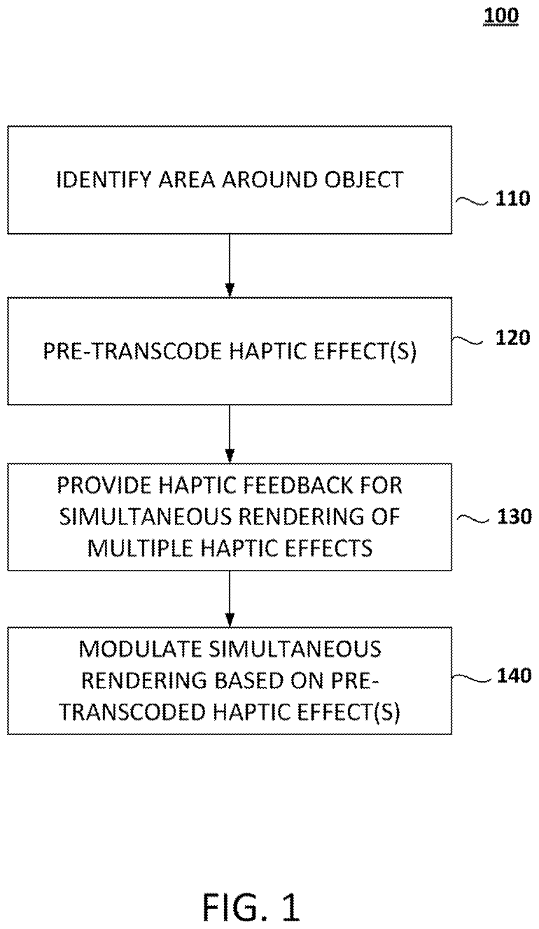

FIG. 1 is a flow diagram of providing haptic feedback 100 by dynamically modulating two or more haptic effects in a XR environment according to an embodiment.

Referring to FIG. 1, providing haptic feedback 100 includes, at 110, identifying an area, including a first displayed content or object and a second displayed content or object, around a user in an XR environment.

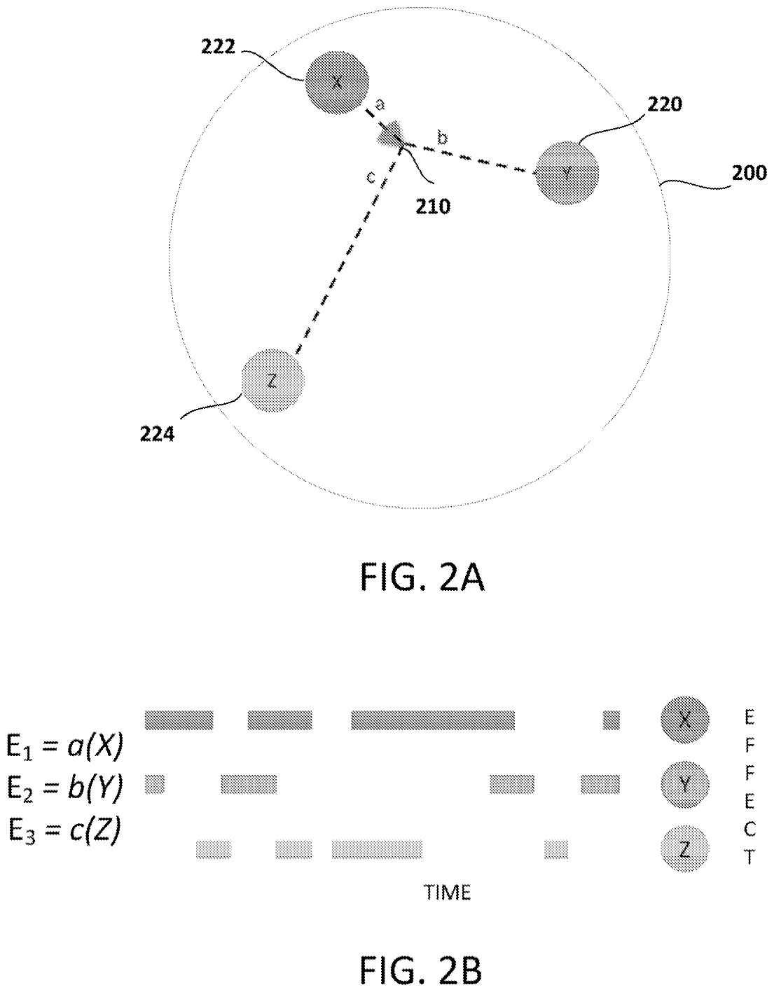

FIG. 2A is a diagram of an area 200 around a user 210 according to an embodiment. Although area 200 is shown as being circular, embodiments are not limited thereto, and thus area 200 can have any shape intended by a haptic editor. Area 200 can be symmetrical. Alternatively, area 200 can be asymmetrical.

Area 200 includes two or more objects 220, 222, 224. Objects 220, 222, 224 are content sources for which one or more haptic effects can be produced. The location (or position) of objects 220, 222, 224 within area 200 can be determined by a haptic editor. Objects 220, 222, 224 can be at different distances from user 210. In FIG. 2A, the distance between object 220 and user 210 is denoted as distance b. The distance between object 222 and user 210 is denoted as distance a. The distance between object 224 and user 210 is denoted as distance c.

FIG. 2B is a playback timing chart of the haptic effects shown in FIG. 2A. Referring to FIG. 2B, in accordance with embodiments, haptic effects can be simultaneously rendered for at least two of objects 220, 222, 224 at a given time. As explained in detail below, each haptic effect (E) can be rendered at a specific parameter/strength level based on an intent of the haptic editor. For instance, based on the distance of user 210 to each of objects 220, 222, 224, the haptic effect E₁ for object 222 can be rendered at full strength (e.g., E₁=1*X) whereas the haptic effect E₂ for object 220 can be rendered at 50% (e.g., E₂=0.5*Y) and the haptic effect E₃ for object 224 can be rendered at 10% (e.g., E₃=0.1*Z).

The haptic effects for objects 220, 222, 224 can include vibrotactile haptic effects, electrostatic friction haptic effects, ultrasonic haptic effects, temperature variation, deformation haptic effects and/or any other form of haptic effects. One or more of the haptic effect(s) for objects 220, 222, 224 can be of a different type than one or more of the other haptic effects. Alternatively, one or more of the haptic effects can be of a same type but have different haptic parameters than one or more of the other haptic effects.

Referring back to FIG. 1, at 120, each haptic effect is pre-transcoded with a set number of levels x₁₊ₙ (where n is an integer equal to or greater than zero) of one or more of the haptic parameters, based on an intent of the haptic editor. The intent of the haptic editor can be stored within a haptic effect way input file coded for an original haptic effect. The intent of the haptic editor is how the haptic effect(s) should be rendered to the viewer as the viewer experiences the XR environment. For instance, if the intent of the haptic editor is to modulate the strength of the haptic effects, the original haptic effect (which is rendered at a parameter (or strength) level of 100%) (a parameter level of 100% is referred to as the “original parameter level” or “initial parameter level” or “I₀”) can be transcoded with a number of different parameter levels, l₁₊ₙ wherein n is an integer equal to or greater than zero. For example, a first parameter (or strength) level I₁ can be 50% of the original parameter level I₀, a second parameter (or strength) level I₂ can be 75% of the original parameter level I₀, a third parameter (or strength) level I₃ can be 125% of the original parameter level I₀, and a fourth parameter (or strength) level I₄ can be 150% of the original parameter level I₀.

The different parameter levels I₁₊ₙ and the original parameter level I₀, collectively, are bundled together in a modified haptic effect way input file (effectID).

At 130, haptic feedback is provided by hardware (e.g., haptic output device, actuator or other output mechanism) embedded in a haptically-enabled device in response to haptic drive signal(s) including instructions for simultaneous rendering of the first original haptic effect and the second original haptic effect. The haptic drive signal includes instructions specifying which haptic effect(s) to playback and how to playback the haptic effect(s).

In an embodiment, the instructions for simultaneous rendering of the first original haptic effect and the second original haptic effect can include instructions specifying to playback the first original haptic effect at its original (or initial) parameter level x₀ and the second original haptic effect at its original (or initial) parameter level y₀.

Alternatively, in another embodiment, the instructions for simultaneous rendering of the first original haptic effect and the second original haptic effect can include instructions specifying to playback one of the first original haptic effect at its original parameter level x₀ or the second original haptic effect at its original parameter level y₀, and a remaining one of the first original haptic effect or the second original haptic effect at a parameter level different than its original parameter level.

The embedded hardware is programmed to render (or playback) haptic effects, such as vibrotactile haptic effects, electrostatic friction haptic effects, ultrasonic haptic effects, temperature variation, and/or deformation haptic effects, in response to the haptic drive signal. An example of the haptically-enabled device includes any type of handheld/mobile device such as a cellular telephone, personal digital assistant (“PDA”), smartphone, computer tablet, gaming console, controller or split controller, remote control, a vehicle or parts of a vehicle such as a steering wheel, head-up display (“HUD”), dashboard or seat, a wearable device such as wristband, headband, eyeglasses, ring, leg band, an array integrated into clothing, furniture, visual display board, or any device having an output mechanism.

At 140, the simultaneous rendering of the first original haptic effect and the second original haptic effect is modulated by rendering the first haptic effect at a parameter (or strength) level x₁ from among the set number of parameter (or strength) levels x₁₊ₙ and/or the second haptic effect at a parameter (or strength level) y₁ from among the set number of strength levels y₁₊ₙ. The number of parameter levels x₁₊ₙ for the first haptic effect can be different than the number of parameter levels y₁₊ₙ for the second haptic effect. Alternatively, the number of parameter levels x₁₊ₙ for the first haptic effect can be equal to the number of parameter levels y₁₊ₙ for the second haptic effect. To render the haptic effect(s) at the strength level, a desired parameter level is called up (or requested) from the modified haptic effect way input file (effectID) by calling a SetParameter (effectID, requested parameter value) API. For example, if the intent of the haptic editor is to modulate the strength of the haptic effect(s), the SetStrength (effectID, requested strength value) API can be called up. As another example, if the intent of the haptic editor is to modulate the haptic effect(s) based on the view of the viewer, the SetAngle (effectID, requested angle value) API can be called up. The parameters can relate to position, distance of the viewer, propagation type (e.g., linear, logarithmic, etc.) of the haptic effect, physical range of the haptic effect, or any other parameter from which the haptic effect is generated.

In an embodiment, the simultaneous rendering of the first original haptic effect and the second original haptic effect is modulated by rendering a first modulated haptic effect at a parameter level x₁ from among the set number of parameter levels x₁₊ₙ and a second modulated haptic effect at a parameter level y₁ from among the set number of parameter levels y₁₊ₙ. The parameter level x₁ is different than an original (or initial) parameter level x₀ of the first original haptic effect. The parameter level y₁ is different than an original (or initial) parameter level y₀ of the second original haptic effect.

In another embodiment, the simultaneous rendering of the first original haptic effect and the second original haptic effect is modulated by rendering the first modulated haptic effect at a parameter level x₁ from among the set number of parameter levels x₁₊ₙ and the second original haptic effect at the original parameter level y₀. Alternatively, the second modulated haptic effect is played back at the parameter level y₁, and the first original haptic effect is played back at the initial parameter level x₀.

In an embodiment, the parameter level is selected based on the proximity of the user (e.g., a viewer) to the objects. The parameter level x₁ is based on proximity of the first object to the user. The parameter level y₁ is based on proximity of the second object to the user. For example, if a viewer is between object 222 and object 220, but closer to object 222 than to object 220, a strength level (x₁=0.75x₀) can be called up for the first haptic effect (E₁=x₁) and a strength level (y₂=0.50y₀) can be called up for the second haptic effect (E₂=x₂). The strength level x₁ is 75% of the initial strength of the first haptic effect, and the strength level y₂ is 50% of the initial strength of the second haptic effect. The strength level of the first haptic effect will increase up to or more than the initial strength of the first haptic effect, the closer the viewer moves to object 222. And, the strength level of the second haptic effect will further decrease, the further the viewer moves away from object 220.

In an embodiment, the parameter level is selected based on importance of the object to the user. The parameter level x₁₊ₙ is selected based on importance of the first object to the user. The parameter level y₁₊ₙ is selected based on importance of the second object to the user. Thus, referring to FIGS. 2A and 2B, parameter level x₁₊ₙ can be selected based on importance of object 222 to user 210, parameter level z₁₊ₙ can be selected based on importance of object 224 to user 210, and/or parameter level parameter level y₁₊ₙ can be selected based on importance of object 220 to user 210. For instance, if an avatar is traversing a dungeon, and the avatar casts a spell to help her detect magic items in the dungeon. As the avatar approaches a magic item, a parameter of a first haptic effect is changed (e.g., strength of the first haptic effect is increased) to let the user know that that the avatar is getting closer to magic item. As the avatar approaches the magic item and hears a roar followed by an increasing warmth, a second haptic effect is rendered as the roar commences and a parameter of the second haptic effect is changed (e.g., the strength of the second haptic effect is increased) as the warmth increases, while the parameter of the first haptic effect is either held constant or changed (e.g., the strength of the first haptic effect is decreased) to reflect that the avatar's attention is on the increasing warmth rather than with magic item. As the avatar turns and sees a fireball coming toward her and experiences an explosion as she lifts her magical shield to stop the fireball, the strength of the second haptic effect is increased to a maximum parameter value and the first haptic effect is decreased to a minimum parameter value to reflect that all of the avatar's attention is on the explosion. As the explosion diminishes and the avatar finds the magic item, the parameter of the first haptic effect is increased to a maximum parameter value, and the parameter of the second haptic effect is steadily decreased in correlation with the diminishing explosion.

In yet another embodiment, the parameter level is selected based on a combination of proximity of the user (e.g., a viewer) to the objects, and importance of the objects to the user.

For each haptic effect to be played, the parameter level selected to be played, for example, by a SDK, would the parameter level that is nearest to the parameter value requested. For instance, the first haptic effect could be pre-transcoded into a first parameter level x₁ that is 50% of the original parameter level x₀, a second parameter level x₂ that is 75% of the original parameter level x₀, a third parameter level x₃ that is 125% of the original parameter level x₀, and a fourth parameter level x₄ that is 150% of the original parameter level x₀. Assuming that the parameter value selected is 80% of the original parameter level x₀, then the first haptic effect would be played at the second parameter level x₂.

In an embodiment, the providing of the haptic feedback at 130 and the modulating the simultaneous rendering of the first original haptic effect and the second original haptic effect at 140 occur in real-time.

In an embodiment, the modulating of the second original haptic effect at 140 is repeated in response to movement of the user.

Dynamic modification of multiple haptic effects for a 360 video will now be described. 360 video playback can be a specific case where the viewer is limited to only changing the view direction rather than the location. This limitation helps avoid using interleaving-mixing. Also, in other media playback, it is desirable to treat the video as a single effect.

However, embodiments are not limited thereto, and the 360 video playback can be a case where the viewer can change location and direction.

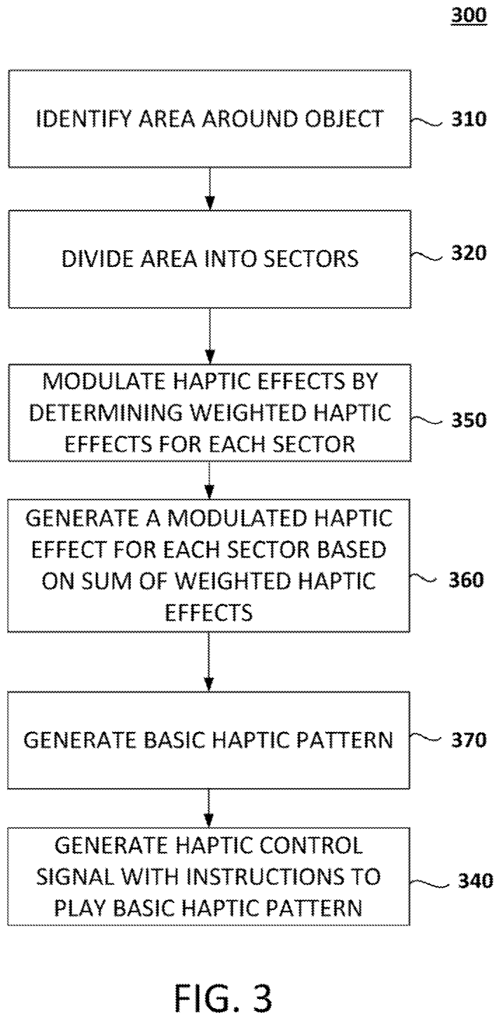

FIG. 3 is a flow diagram of providing haptic feedback 300 by dynamically modifying two or more haptic effects in a 360 video according to an embodiment.

Referring to FIG. 3, providing haptic feedback 300 includes, at 310, identifying a three-dimensional (3D) area around a user in the 360 video. The user is positioned at a center of the 3D area. Two or more objects are within the 3D area.

At 320, the 3D area is divided into a plurality of 3D sectors. In an embodiment, the total number of the 3D sectors is in a range between 8 sectors to 360 sectors. In another embodiment, the total number of the 3D sectors is in a range between 16 sectors to 360 sectors.

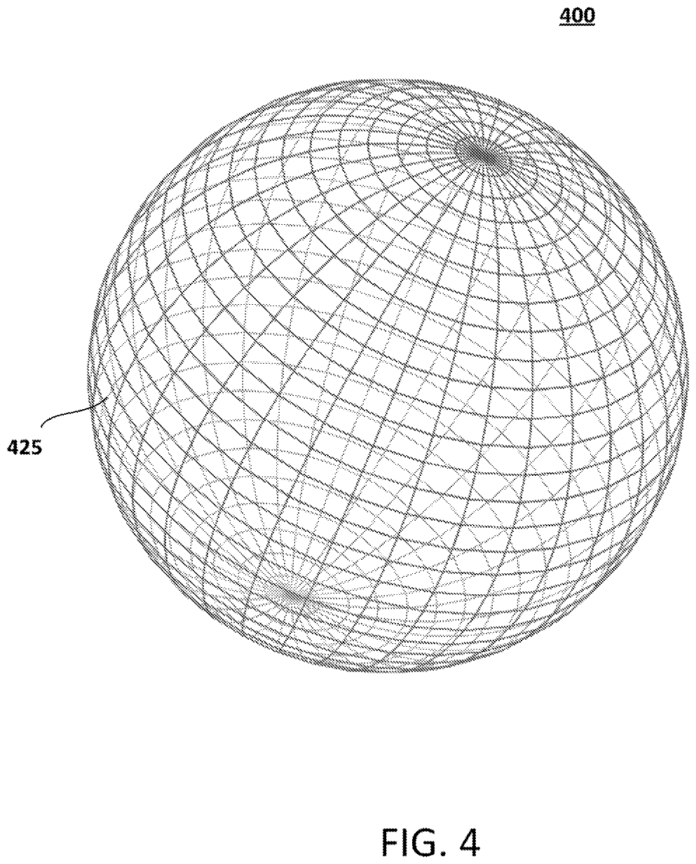

FIG. 4 is a diagram of an area 400 around a user according to an embodiment. Although area 400 is shown as a sphere, embodiments are not limited thereto, and thus area 400 can be have any shape identified by a haptic editor. Area 400 can be symmetrical. Alternatively, area 400 can be asymmetrical. Area 400 is divided into sectors 425. Area 400 can be divided into sectors 425 each having a different shape than each other. Alternatively, area 400 can be divided into sectors 425 each having a same shape as each other. In yet another embodiment, area 400 can be divided into sectors 425 where one or more sectors have a first shape (e.g., rectangular pyramid), and one or more other sectors have a second shape that is different than the first shape (e.g., conical). For a 360-degree video, the number of the sectors is determined by dividing 360-degrees by the desired sector angle (e.g., if the desired sector angle is 1°, then there will be 360 sectors). For fine granularity, the resolution is set at 360×360. However, embodiments are not limited thereto.

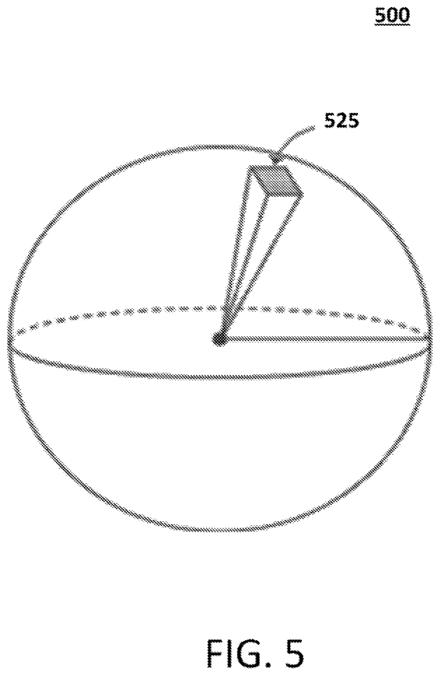

FIG. 5 is a diagram of a sector according to an embodiment.

Referring to FIG. 5, sector 525 is shaped in the form of a rectangular pyramid. A rectangular pyramid is a three-dimensional shape with a rectangle for a base and a triangular face corresponding to each side of the base. The triangular faces, which are not the rectangular base, are called lateral faces and meet at a point called the vertex or apex. The rectangular pyramid originates from a center of area 500, and extends outwards.

However, embodiments are not limited thereto, and the shape of sector 525 can be determined by other factors. For instance, in an embodiment, the shape of sector 525 can be determined by the haptic editor. In another embodiment, the shape of sector 525 can be determined based on the shape of the area around the user.

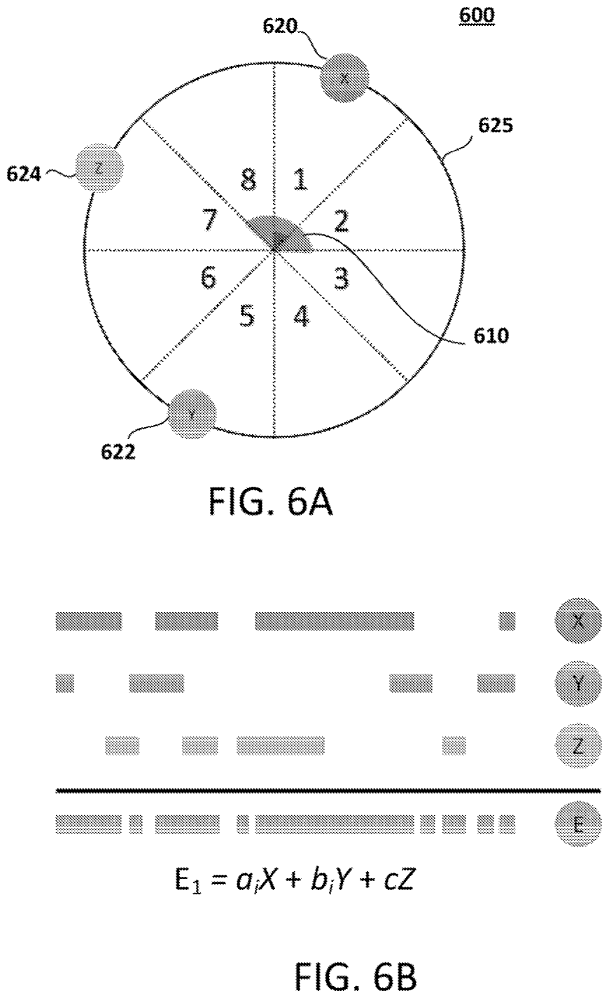

In an embodiment, an object is positioned in at least one of the sectors. FIG. 6A is a cross-sectional diagram of an area 600 around a user 610 according to an embodiment. Area 600 is divided into eight 3D sectors 625. Two or more objects 620, 622, 624 are in one of the eight sectors 625. As shown, a first object 620 is in sector number 1, a second object 622 is in sector number 5, and a third object 624 is in sector number 7. Objects 620, 622, 624 are sources for which one or more haptic effects can be produced. A haptic editor can determine which one of the 3D sectors 625 to position objects 620, 622, 624 in. Objects 620, 622, 624 can be at different distances from user 610.

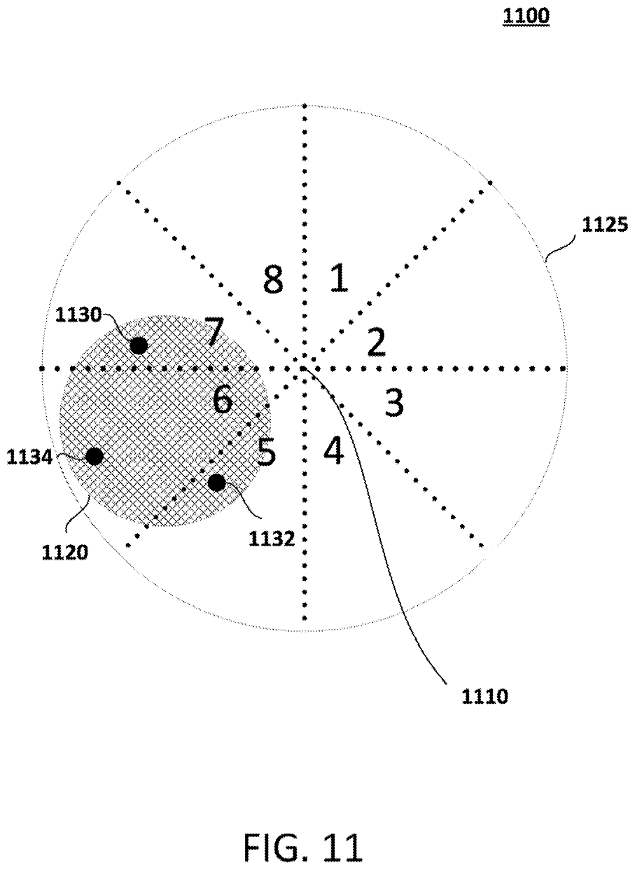

In another embodiment, a single object is positioned in more than one of the sectors. FIG. 11 is a cross-sectional diagram of an area 1100 around a user 1110 according to an embodiment. Area 1100 is divided into eight 3D sectors 1125 (sectors number 1-8). Object 1120 extends into sectors number 5, 6 and 7. Two or more object elements 1130, 1132, 1134, which are each associated with a haptic effect for object 1120, are in one of the eight sectors 1125. As shown, a first object element 1130 is in sector number 7, a second object element 1132 is in sector number 5, and a third object element 1134 is in sector number 6. Object elements 1130, 1132, 1124 each correspond to a different haptic effect. For instance, if object 1120 is a speed car, object element 1132 can correspond to the engine of the car being revived up, object element 1130 can correspond to a horn of the car being blown, and object element 1134 can correspond to the back tires of the car spinning on the road. A haptic editor can determine which one of the 3D sectors 1125 to position object elements 1130, 1132, 1134 in. Object elements 1130, 1132, 1134 can be at different distances from user 1110.

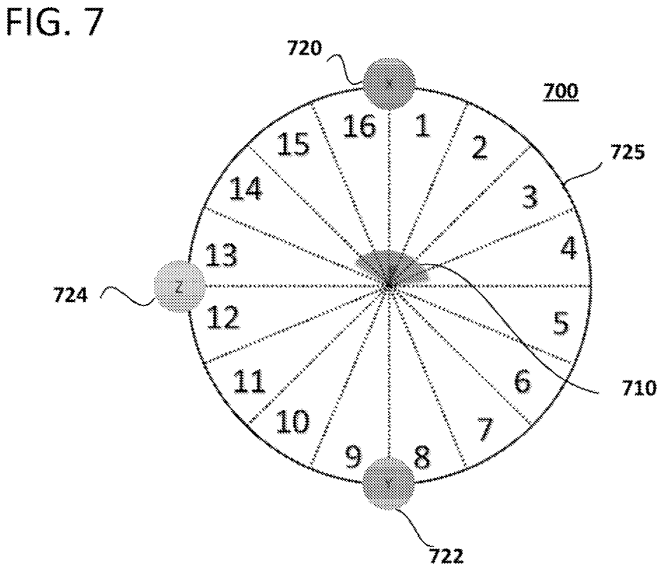

In another embodiment, an object is positioned partially in one sector and partially in another sector. FIG. 7 is a cross-sectional diagram of an area 700 around a user 710 according to an embodiment. Area 700 is divided into sixteen 3D sectors 725. Two or more objects 720, 722, 724 are each positioned partially in one of the sectors 725 and partially in another of the sector 725. As shown, a first object 720 is partially in sector number 1 and partially in sector number 16, a second object 722 is partially in sector number 9 and partially in sector number 8, and a third object 724 is partially in sector number 12 and partially in sector number 13. Objects 720, 722, 724 are sources for which one or more haptic effects can be produced. A haptic editor can determine which two of the 3D sectors 725 to position objects 720, 722, 724 in. Objects 720, 722, 724 can be at different distances from user 710.

In yet another embodiment, one or more first objects (e.g., similar to objects 720, 722 and 724 in FIG. 7) are positioned partially in one sector and partially in another sector, and one or more second objects are positioned in at least one of the sectors (e.g., similar to objects 620, 622 and 624 in FIG. 6B).

FIG. 6B is a playback timing chart of the haptic effects shown in FIG. 6A.

Referring to FIG. 6B, in accordance with embodiments, haptic effects can be simultaneously rendered for at least two of objects 620, 622, 624 at a given time.

The haptic effects for objects 620, 622, 624 can include vibrotactile haptic effects, electrostatic friction haptic effects, ultrasonic haptic effects, temperature variation, deformation haptic effects and/or any other form of haptic effects. One or more of the haptic effect(s) for objects 620, 622, 624 can be of a different type than one or more of the other haptic effects. Alternatively, one or more of the haptic effects can be of a same type but have different haptic parameters than one or more of the other haptic effects.

Referring back to FIG. 3, the haptic effects for the objects are modulated by determining, for each sector in the area, a weighted haptic effect for each object, at 350. The weighted haptic effect is determined by assigning a weight to the haptic effect for each object. In an embodiment, the weight is based on importance of the object to the user. For example, the weight can be based on importance of the object to a view, a hearing, a smell and/or a touch of the user.

In an embodiment, the weight is generated by performing a calculation taking at least one of the following factors into consideration: the position of the object, the user's viewing angle of the object, propagation type (e.g., linear, logarithmic, etc.), propagation distance, angular distance, and/or the physical range of the haptic effect. In an embodiment, the calculation is an algorithm using the following: number of sectors for each object, viewing sector for each object, propagation distance for each object, and the result of a propagation algorithm (e.g., a Gaussian algorithm). In an embodiment, the propagation distance is an angular distance, the angular distance being the angle range in which the haptic effect is felt.

In a 360-degree video, the distance from the user is constant and taken into account when the original haptic effect is designed. Therefore, in an embodiment, the distance from the user is not a factor in the calculation.

The intent of the haptic editor can be stored within a haptic effect way input file coded for the original haptic effects. The intent of the haptic editor is how the haptic effect(s) should be rendered to the viewer as the user experiences the XR environment. The position of the haptic effects, the user's viewing angle of the object, and/or the distance of the user to the object can impact the strength by which the haptic effects are modulated to affect how the haptic effects are perceived by a viewer. For instance, if the intent of the haptic editor is to modulate the haptic effects according to the user's viewing angle of the object, a first weight can be assigned to object(s) positioned between 270°-359° from the viewpoint of the user, a second weight can be assigned to object(s) positioned between 0°-89° from the viewpoint of the user, a third weight can be assigned for object(s) positioned between 90°-179° from the viewpoint of the user, and a fourth weight can be assigned for object(s) positioned between 180°-269° from the viewpoint of the user. In an embodiment, a different weight can be assigned for each sector.

For sector number 1 shown in FIG. 6A, object 620 may be assigned a weight of 1, and objects 622 and 624 may be assigned a weight of zero (0). For a sector that has no objects therein and is directly adjacent to a sector having an object, the object may be assigned a weight of 0.5 (or 50% of the original haptic effect), in accordance with the haptic editor's intent. Thus, for sector 6, object 622 is assigned a weight of 0.5, and object 624 is assigned a weight of 0.5. For a sector that has no objects therein and is more than one sector away from a sector having an object, the object may be assigned a weight of zero (0), in accordance with the haptic editor's intent. Thus, for sector 6, object 620 is assigned a weight of 0.

However, embodiments are not limited thereto. For example, in FIG. 7, for a sector that has no objects therein and is directly adjacent to a sector having an object, the object may be assigned a weight of 0.75 (or 75% of the original haptic effect), in accordance with the haptic editor's intent. Thus, for sector 10, object 722 is assigned a weight of 0.75. In FIG. 7, for a sector that has no objects therein and is two sectors away from a sector having an object, the object may be assigned a weight of 0.25 (or 25% of the original haptic effect), in accordance with the haptic editor's intent. Thus, for sector 10, object 724 is assigned a weight of 0.25. In FIG. 7, for a sector that has no objects therein and is more than two sectors away from a sector having an object, the object may be assigned a weight of zero (0), in accordance with the haptic editor's intent. Thus, for sector 10, object 720 is assigned a weight of 0.

Referring back to FIG. 3, at 360, a modulated haptic effect is generated for each of the 3D sectors based on a sum of the weighted haptic effect for each object. For instance, for sector number 1 shown in FIG. 6A, a sum of the weighted haptic effects is determined by the haptic effect for object 620. For sector number 6, a sum of the weighted haptic effects is determined by object 622 and object 624.

At 370, one or more basic haptic patterns are generated by transcoding the modulated haptic effect from at least one of the 3D sectors based on the haptic editor's intent. A single haptic file (e.g., a single haptic playback track, or a HAPT file), which includes the basic haptic pattern(s), is generated. For instance, the sum of the first weighted haptic effect, the second weighted haptic effect, and the third weighted haptic effect, for sector number 1 in FIG. 6A, is transcoded into a first basic haptic pattern. Likewise, the sum of the first weighted haptic effect, the second weighted haptic effect and the third weighted haptic effect, for sector number 6, is transcoded into a second basic haptic pattern, and so forth. The first basic haptic pattern and the second basic haptic pattern are stored in a haptic playback track.

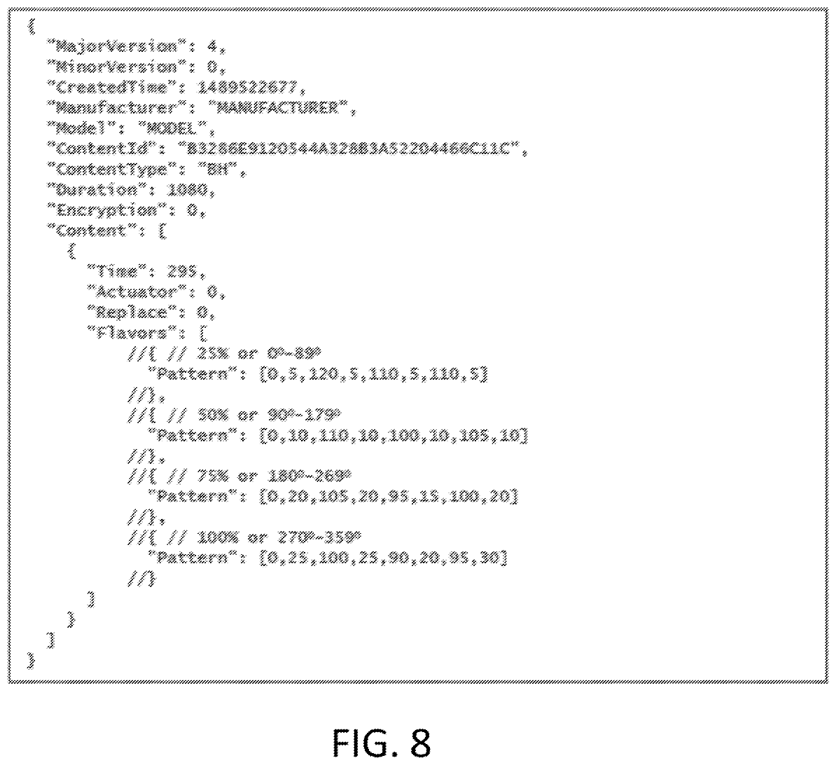

At 340, a haptic control signal is generated including instructions to playback basic haptic pattern(s) from the haptic playback track to provide haptic feedback. The instructions can be encoded in a HAPT file format as shown in FIG. 8 (which is described in further detail below).

In an embodiment, a single haptic file, which includes all of the basic haptic patterns (e.g., the first basic haptic pattern and the second basic haptic pattern), is loaded in a playback queue. The playback queue is sorted by timestamp.

If using XML Path Language (“XPath”) to make an query, playback of each the basic haptic patterns occurs based on a value of a current node or a context node.

The current node is the node that an XPath processor is looking at when it begins evaluation of a query. The current node is the first context node that the XPath processor uses when it starts to execute the query. During evaluation of a query, the current node does not change.

A context node is the node the XPath processor is currently looking at. The context node changes as the XPath processor evaluates a query.

On the next playback, the current node is updated for a flavor. A “flavor” as used herein is a means to play different patterns/tracks according to real-time location, angle and/or strength inputs. The HAPT file is updated to support different flavors. Each flavor contains a basic haptic pattern.

If the first basic haptic pattern belongs to the flavor, then the first basic haptic pattern is played at a first timestamp. At the first timestamp, a first modulated haptic effect is rendered by playback of the first basic haptic pattern.

If the current node is updated to a new flavor and the second haptic pattern belongs to the new flavor, then the second basic haptic pattern is played at a second timestamp. The second timestamp can occur after the first timestamp. At the second timestamp, a second modulated haptic effect is rendered by playback of the second basic haptic pattern.

The generation of the second modulated haptic effect may at least partially overlap with the generation of the first modulated haptic effect to provide an unnoticeable (or barely noticeable) transition between playback.

In another embodiment, a basic haptic pattern is selected based on a flavor to generate a first selected basic haptic pattern, and the first selected basic haptic pattern is loaded in a playback queue. On the next playback, the first selected basic haptic pattern is played at a respective timestamp. At the respective timestamp, first modulated haptic effect is rendered by playback of the first selected basic haptic pattern.

If the current node is updated to a new flavor, the playback queue is cleared, and a new basic haptic pattern is selected to generate a second selected basic haptic pattern, and the second selected basic haptic pattern is loaded in the playback queue. On the next playback, the second selected basic haptic pattern is played at a respective timestamp. At the respective timestamp, a second modulated haptic effect is rendered by playback of the second selected basic haptic pattern.

If the new flavor contains more than one basic haptic pattern, a new basic haptic pattern is selected to generate a third selected basic haptic pattern, and the third selected basic haptic pattern is loaded in the playback queue without clearing the playback queue. On the next playback, a third modulated haptic effect is rendered by playback of the third selected basic haptic pattern at the respective timestamp. The rendering of the second modulated haptic effect may at least partially overlap with the rendering of the third modulated haptic effect to provide an unnoticeable (or barely noticeable) transition between playback.

In an embodiment, the rendering of a second or subsequent modulated haptic effect occurs in response to a change in a point-of-view of the user.

In an embodiment, the HAPT file format is configured to support multiple pre-transcoded patterns for a single haptic effect (Content ID) or multiple basic haptic patterns. In an embodiment, multiple APIs can be introduced, on the SDK playback. In another embodiment, one API can be introduced, on the SDK playback.

FIG. 8 is a HAPT file format according to an embodiment.

In FIG. 8, different patterns flavors are established based on strength or angle.

On the SDK playback, two APIs can be introduced: (i) SetStrength (effectID, strength), and (ii) SetAngle (effectID, angle). The SDK can load the entire effect from the HAPT file into memory. Each time a basic haptic pattern is to be played the current strength or angle requested is translated to the closest corresponding pattern flavor, which is eventually sent to the API.

The SDK can receive a strength or angle value, and adapt the playback accordingly. It is up to the calling application to perform any required calculations to determine the strength or angle values following XR related operations (turning, moving, etc.). The SDK will strive for a smooth playback by deciding to ignore fast or minor transitions.

In an embodiment, a haptic playback track, which is the signal specifying which basic haptic pattern to play, can be designed or generated using a digital audio workstation (“DAW”) (an electronic device or application software used for recording, editing and producing audio files such as an non-linear editor (“NLE”), real-time editing system, or a XR system.

An NLE according to an embodiment is a form of audio, video or image editing where the original content is not modified in the course of editing. The edits in an NLE are specified and modified by specialized software.

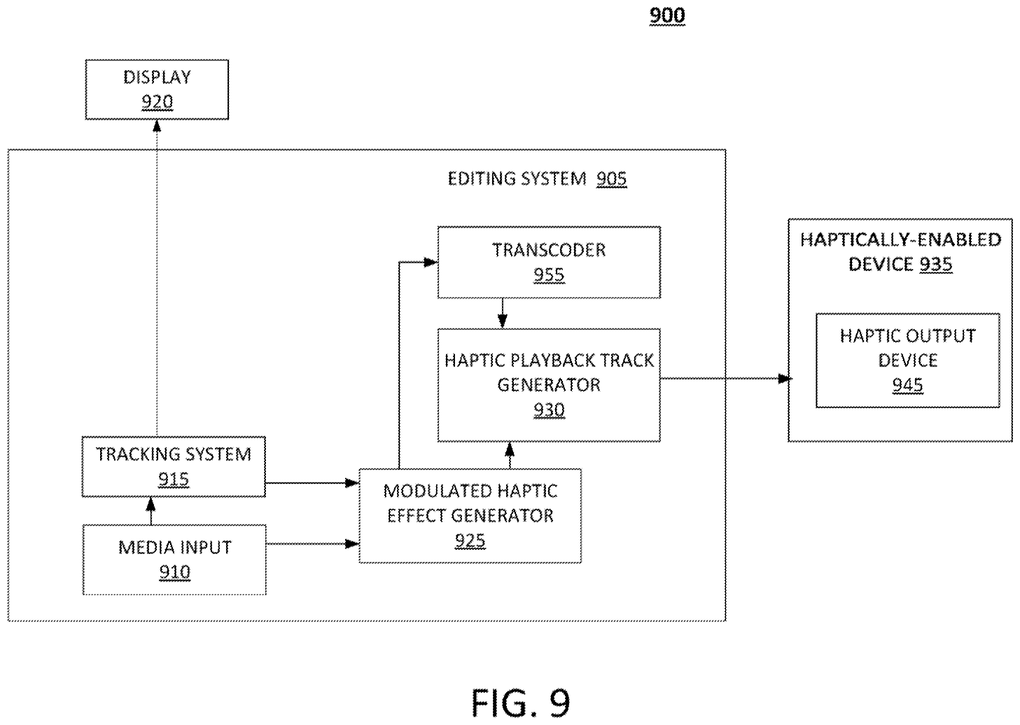

FIG. 9 is block diagram of a haptic design system according to an example embodiment.

Referring to FIG. 9, an editing system 905 according to example embodiments receives input (e.g., a video, audio or image) from an XR environment through a media input 910. Editing system 905 can be an NLE. The input can be a 360 video.

Editing system 905 includes a tracking system 915 that identifies a 3D area, including a first object and a second object, around a user during playback.

Playback can be viewed through windows on a visual display 920 connected to editing system 905. Visual display 920 can be a computer screen, a mobile device screen or a head-mounted display (“HMD”). During playback of the video, the editor can control of the viewing direction like a panorama. Thus, the editor can pan around the video from a viewing angle or perspective of the user.

Editing system 905 includes a modulated haptic effect generator 925.

In an embodiment, modulated haptic effect generator 925 pre-transcodes each haptic effect in the area identified by tracking system 915 based on the intent of the haptic editor as described above at 120 in FIG. 1.

In another embodiment, modulated haptic effect generator 925 divides the area identified by tracking system 915 into 3D sectors, and modulates, for each 3D sector in the area, the haptic effects for the objects by determining a weighted haptic effect for each object as described above at 350 in FIG. 3. Modulated haptic effect generator 925 generates a modulated haptic effect for each 3D sector based on a sum of the weighted haptic effect for each object as described above at 360 in FIG. 3.

In an embodiment, editing system 905 further includes a haptic playback track generator 930 that generates a haptic playback track based on the pre-transcoded haptic effect(s) received from modulated haptic effect generator 925.

In another embodiment, editing system 905 includes a transcoder 955 that generates basic haptic pattern(s) by transcoding the modulated haptic effect(s) received from modulated haptic effect generator 925. In this embodiment, haptic playback track generator 930 generates a haptic playback track based on basic haptic patterns(s) received from transcoder 955.

Haptic playback track generator 930 outputs one or more of the haptic playback track or a haptic file containing multiple haptic playback tracks, and optionally, a metadata file, to a haptically-enabled device 935.

Editing system 905 can be electrically and wirelessly connected to haptically-enabled device 935. Haptically-enabled device 935 can be a mobile device, a console, a computer, a handheld game controller, a VR/AR controller or another peripheral device (e.g., a game pad, a computer mouse, a trackball, a keyboard, a tablet, a microphone, and a headset, or a wearable).

The haptic effect(s) is/are applied by haptically-enabled device 935. Haptic effects can be applied as a vibrotactile haptic effect, a deformation haptic effect, an ultrasonic haptic effect, and/or an electrostatic friction haptic effect. Application of the haptic effects can include applying a vibration using a tactile, deformation, ultrasonic and/or electrostatic source.

Haptically-enabled device 935 according to example embodiments includes a haptic output device 945. Haptic output device 945 is a device that includes mechanisms configured to output (or render) any form of haptic effects, such as vibrotactile haptic effects, electrostatic friction haptic effects, deformation haptic effects, ultrasonic haptic effects, etc. in response to the haptic drive signal.

Haptic output device 945 can be an electric motor, an electro-magnetic actuator, a voice coil, a shape memory alloy, a solenoid, an eccentric rotating mass motor (“ERM”), a linear resonant actuator (“LRA”), an electromechanical actuator (such as a piezoelectric actuator or an electroactive polymer (“EAP”) actuator), or any other device configured to apply the haptic effect(s). In an example embodiment, the piezoelectric actuator can be a ceramic actuator or a macro-fiber composite (“MFC”) actuator. However, example embodiments are not limited thereto. For instance, a high bandwidth actuator can be used in addition to haptic output device 945.

In an alternative example embodiment, a direct current (“DC”) motor can be used, alternatively or in addition, to haptic output device 945 to apply the vibration.

In other example embodiments, haptically-enabled device 935 can include non-mechanical devices to apply the haptic effect(s). The non-mechanical devices can include electrodes implanted near muscle spindles of a user to excite the muscle spindles using electrical currents firing at the same rate as sensory stimulations that produce the real (or natural) movement, a device that uses electrostatic friction (“ESF”) or ultrasonic surface friction (“USF”), a device that induces acoustic radiation pressure with an ultrasonic haptic transducer, a device that uses a haptic substrate and a flexible or deformable surface or shape changing device and that can be attached to an individual's body, a device that provides projected haptic output such as forced-air (e.g., a puff of air using an air jet), a laser-based projectile, a sound-based projectile, etc.

According to an example embodiment, the laser-based projectile uses laser energy to ionize air molecules in a concentrated region mid-air so as to provide plasma (a concentrated mixture of positive and negative particles). The laser can be a femtosecond laser that emits pulses at very fast and very intense paces. The faster the laser, the safer for humans to touch. The laser-based projectile can appear as a hologram that is haptic and interactive. When the plasma comes into contact with an individual's skin, the individual can sense the vibrations of energized air molecules in the concentrated region. Sensations on the individual skin are caused by the waves that are generated when the individual interacts with plasma in mid-air. Accordingly, haptic effects can be provided to the individual by subjecting the individual to a plasma concentrated region. Alternatively, or additionally, haptic effects can be provided to the individual by subjecting the individual to the vibrations generated by directed sound energy.

In an embodiment, editing system 905 and haptic output device 945 are within a single housing of haptically-enabled device 935. For instance, editing system 905 can utilized by firmware controlling haptically-enabled device 935.

In an alternative embodiment, editing system 905 is at a location remote from haptically-enabled device 935, and haptic output device 945 is within haptically-enabled device 935. For instance, editing system 905 can be utilized by software developers through an application programming interface (API). Editing system 905 can be accessed over a network. Network can include one or more local area networks, wide area networks, the Internet, cloud-computing, etc. Further, network can include various combinations of wired and/or wireless networks, such as, for example, copper wire or coaxial cable networks, fiber optic networks, BLUETOOTH wireless networks, WiFi wireless networks, CDMA, FDMA and TDMA cellular wireless networks, etc., which execute various network protocols, such as, for example, wired and wireless Ethernet, BLUETOOTH, etc.

Editing system 905 is accessible by users or software programmers after manufacture and after purchase of haptically-enabled device 935 to enable modulation of haptic effect after manufacture and after purchase of haptically-enabled device 935. By making editing system 905 accessible after manufacture and after purchase of haptically-enabled device 935, the programmable tuning function can be updated or changed based on use and/or age of haptically-enabled device 935, conditions that haptically-enabled device 935 is exposed to, or changeable materials in haptically-enabled device 935 that affect haptic feedback.

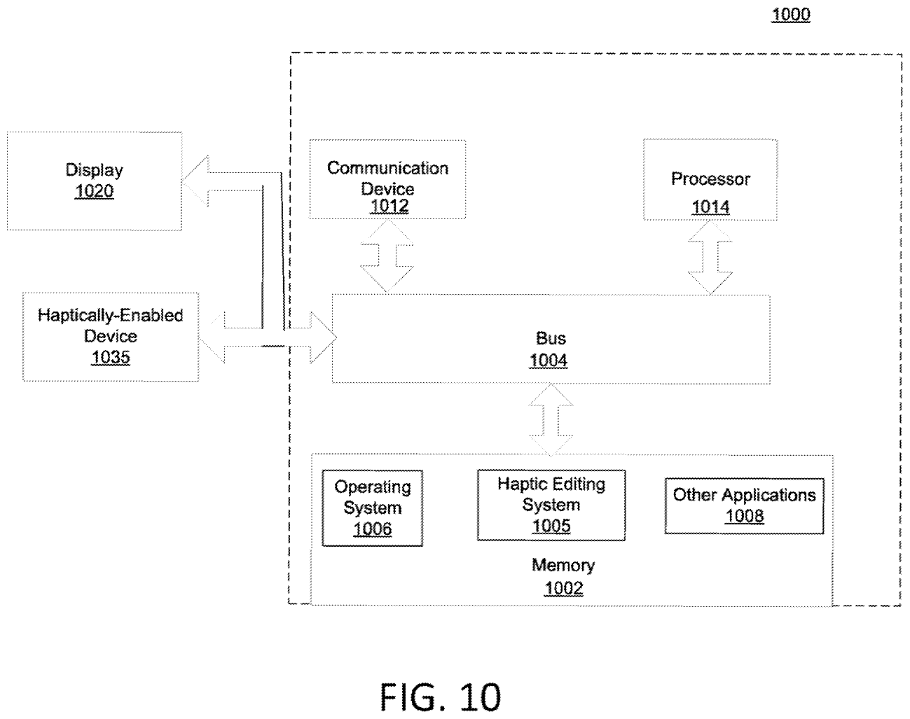

FIG. 10 is a block diagram of a system in an electronic device according to an embodiment.

Referring to FIG. 10, a system 1000 in an electronic device according to an embodiment provides haptic editing functionality for the device.

Although shown as a single system, the functionality of system 1000 can be implemented as a distributed system. System 1000 includes a bus 1004 or other communication mechanism for communicating information, and a processor 1014 coupled to bus 1004 for processing information. Processor 1014 can be any type of general or specific purpose processor. Processor 1014 may be any type of general purpose processor, or could be a processor specifically designed to provide haptic effects, such as an application-specific integrated circuit (“ASIC”). Processor 1014 may be the same processor that operates the entire system 1000, or may be a separate processor. Processor 1014 can decide what haptic effects are to be played and the order in which the effects are played based on high level parameters. In general, the high level parameters that define a particular haptic effect include magnitude/amplitude, frequency and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction.

System 1000 further includes a memory 1002 for storing information and instructions to be executed by processor 1014. Memory 1002 can be comprised of any combination of random access memory (“RAM”), read only memory (“ROM”), static storage such as a magnetic or optical disk, or any other type of non-transitory computer-readable medium.

A non-transitory computer-readable medium can be any available medium that can be accessed by processor 1014, and can include both a volatile and nonvolatile medium, a removable and non-removable medium, a communication medium, and a storage medium. A communication medium can include computer readable instructions, data structures, program modules, or other data in a modulated data signal such as a carrier wave or other transport mechanism, and can include any other form of an information delivery medium known in the art. A storage medium can include random access memory (“RAM”), dynamic RAM (“DRAM”), static RAM (“SRAM”), read only memory (“ROM”), flash memory, cache memory, erasable programmable read-only memory (“EPROM”), electrically erasable programmable read-only memory (“EEPROM”), registers, hard disk, a removable disk, a compact disk read-only memory (“CD-ROM”), or any other form of a storage medium known in the art.

According to an example embodiment, memory 1002 stores software modules that provide functionality when executed by processor 1314. The software modules include an operating system 1006 that provides operating system functionality for system 1000, as well as the rest of the electronic device. The software modules can also include a haptic editing system 1005 that provides haptic modulating functionality (as described above). However, example embodiments are not limited thereto. For instance, haptic editing system 1005 can be external to the electronic device, for example, in a central gaming console in communication with the electronic device. The software modules further include other applications 1008, such as, a video-to-haptic conversion algorithm.

System 1000 can further include a communication device 1012 (e.g., a network interface card) that provides wireless network communication for infrared, radio, Wi-Fi, or cellular network communications. Alternatively, communication device 1012 can provide a wired network connection (e.g., a cable/Ethernet/fiber-optic connection, or a modem).

Processor 1014 is further coupled via bus 1004 to a visual display 1020 for displaying a graphical representation or a user interface to an end-user. Visual display 1020 can be a touch-sensitive input device (i.e., a touch screen) configured to send and receive signals from processor 1014, and can be a multi-touch touch screen.

System 1000 further includes a haptically-enabled device 1035. Processor 1014 can transmit a haptic control signal associated with a haptic effect to haptically-enabled device 1035, which in turn outputs haptic effects (e.g., vibrotactile haptic effects or deformation haptic effects).

Processor 1014 outputs the haptic control signals to a haptic drive circuit in haptically-enabled device 1035, which includes electronic components and circuitry used to supply one or more haptic output devices within haptically-enabled device 1035 with the required electrical current and voltage (i.e., “motor signals”) to cause the desired haptic effects. The haptic drive circuit is configured to generate one or more haptic drive signals. In certain embodiments, the haptic drive circuit may comprise a variety of signal processing stages, each stage defining a subset of the signal processing stages applied to generate the haptic control signal.

The haptic output device can be an electric motor, an electro-magnetic actuator, a voice coil, a solenoid, an eccentric rotating mass motor (“ERM”), a harmonic ERM motor (“HERM”), a linear resonance actuator (“LRA”), a solenoid resonance actuator (“SRA”), an electrostatic friction display, an ultrasonic vibration generator, a piezoelectric actuator, a ceramic actuator or an actuator including smart material(s) such as a shape memory alloy, or an electro-active polymer (“EAP”).

The haptic output device can be a HD actuator, a non-HD actuator as well as other actuator types, and each actuator may include a separate drive circuit, all coupled to a common processor 1014.

System 1000 may be any type of handheld/mobile device, such as a cellular telephone, personal digital assistant (“PDA”), smartphone, computer tablet, gaming console, controller or split controller, remote control, a vehicle, or any other type of device that includes a haptic effect system that includes one or more actuators. System 1000 may be a wearable device such as wristbands, headbands, eyeglasses, rings, leg bands, arrays integrated into clothing, etc., or any other type of device that a user may wear on a body or can be held by a user and that is haptically enabled, including furniture or a vehicle steering wheel or dashboard or seat. Further, some of the elements or functionality of system 1000 may be remotely located or may be implemented by another device that is in communication with the remaining elements of system 1000.

While the above examples pertain to gaming, the embodiments described herein are not limited to gaming and hence can be exploited for automobiles, sports training, real estate, mental health, medicine, health care, retail, space travel, design, engineering, interior design, television and film, media, advertising, marketing, libraries, museums, education, news, music, travel, etc.

While the above embodiments have described in terms of a haptic signal, one of ordinary skill in the art can appreciate that embodiments also apply to the dynamic modulation of an audio signal or light.

Embodiments of the present invention provide an immersive experience of XR haptic playback by modulating multiple haptic effects in relation to the viewer's direction/orientation and location in a XR space.

Embodiments of the present invention provide for simultaneous rendering of two or more modulated haptic effects, and/or modulation of multiple haptic effects to create a new haptic effect that is based the multiple haptic effects playing in parallel to each other.

Several embodiments have been specifically illustrated and/or described. However, it will be appreciated that modifications and variations of the disclosed embodiments are covered by the above teachings and within the purview of the appended claims without departing from the spirit and intended scope of the invention.

What is claimed is:

1. A haptic feedback system comprising:
a haptic output device configured to output a haptic feedback; and
a processor configured to:
identify a three-dimensional (3D) area around a user;
divide the 3D area into a plurality of 3D sectors; and
determine at least one haptic effect based on content displayed relative to the 3D area, the content comprising at least one object displayed in at least one 3D sector of the plurality of 3D sectors.

2. The haptic feedback system of claim 1, wherein the processor is further configured to modulate the at least one haptic effect by determining, for each of the plurality of 3D sectors, at least one weighted haptic effect.

3. The haptic feedback system of claim 2, wherein the processor is further configured to generate a modified haptic effect for each of the plurality of 3D sectors based on a sum of the at least one weighted haptic effect.

4. The haptic feedback system of claim 3, wherein the processor is further configured to provide the haptic feedback in response to a haptic control signal including instructions to playback a haptic pattern transcoded from the modified haptic effect.

5. The haptic feedback system of claim 4, wherein the at least one weighted haptic effect is determined based on an angle at which the user views the at least one object.

6. The haptic feedback system of claim 4, wherein the at least one weighted haptic effect is determined based on a distance between the user and the at least one object.

7. The haptic feedback system of claim 4, wherein the at least one weighted haptic effect is determined based on an angle at which the user views the at least one object and a distance between the user and the at least one object.

8. The haptic feedback system of claim 4, wherein the at least one object comprises a first object displayed in a first 3D sector and a second object displayed in a second 3D sector.

9. The haptic feedback system of claim 8, wherein the first 3D sector and the second 3D sector comprise the same 3D sector.

10. The haptic feedback system of claim 8, wherein the at least one weighted haptic effect comprises a first weighted haptic effect for the first object and a second weighted haptic effect for the second object.

11. The haptic feedback system of claim 10, wherein the sum of the at least one weighted haptic effect comprises the sum of the first weighted haptic effect and the second weighted haptic effect.

12. A method of providing haptic feedback, comprising:
identifying a three-dimensional (3D) area around a user;
dividing the 3D area into a plurality of 3D sectors; and
determining at least one haptic effect based on content displayed relative to the 3D area, the content comprising at least one object displayed in at least one 3D sector of the plurality of 3D sectors.

13. The method of claim 12, further comprising modulating the at least one haptic effect by determining, for each of the plurality of 3D sectors, at least one weighted haptic effect.

14. The method of claim 13, further comprising generating a modified haptic effect for each of the plurality of 3D sectors based on a sum of the at least one weighted haptic effect.

15. The method of claim 14, further comprising providing the haptic feedback in response to a haptic control signal including instructions to playback a haptic pattern transcoded from the modified haptic effect.

16. A method of providing haptic feedback, comprising:
identifying an area including at least a first displayed object around a user in an extended reality environment;
pre-transcoding a first original haptic effect into a first number of strength levels;
pre-transcoding a second original haptic effect into a second number of strength levels;
providing haptic feedback for simultaneous rendering of the first original haptic effect and the second original haptic effect; and
modulating the simultaneous rendering by rendering the first original haptic effect at a first strength level from the first number of strength levels and/or the second original haptic effect at second strength level from the second number of strength levels based on the at least a first displayed object.

17. The method of claim 16, wherein the first original haptic effect is rendered by a first displayed object and the second original haptic effect is rendered by a second displayed object.

18. The method of claim 16, wherein both the first original haptic effect and the second original haptic effect are rendered by the first displayed object.

19. The method of claim 16, wherein providing haptic feedback includes providing haptic feedback in response to a haptic drive signal including instructions for simultaneous rendering of the first original haptic effect and the second original haptic effect.

20. The method of claim 16, wherein the first number of strength levels is different than the second number of strength levels.
